(19) United States
(12) Patent Application Publication
(10) Pub. No.: US 2008/0302352 A1
(43) Pub. Date: Dec. 11, 2008

(54) Exhaust Hood and Method of Mounting Same

(76) Inventors: Richard A. Pearce, Byhalia, MS (US); James Marshall Brown, Germantown, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/758,336

(22) Filed: Jun. 5, 2007

(51) Int. Cl. F16M 13/02; F24C 15/20

(52) U.S. Cl. 126/299 R; 248/201

(57) ABSTRACT

An exhaust hood (10) is disclosed having a housing (K1) with a front wall (12), a rear wall (13), two oppositely disposed side walls (14), a top wall (15), and an open bottom (16). The top wall has a pair of key-hole shaped mounting holes (19) therein positioned in an area adjacent the front wall. The rear wall has a bottom edge (23). The exhaust hood also includes a pair of rear mounting brackets (26) and a pair of front mounting brackets (27). The rear mounting brackets have a hood shaped portion (33) configured to receive the bottom edge of the rear wall. Each front mounting brackets includes a hood mounting screw (44) which is configured to be received within the key-hole shaped mounting hole. To mount the housing, the bottom edge of the rear wall is positioned within the hook shaped portion. The housing is then pivoted upwardly so that the hood mounting screws pass through the narrowed portion of the key-hole shaped mounting holes. The housing is then moved rearwardly and locked in place by tightening the hood mounting screws.

### TECHNICAL FIELD

This invention relates generally to exhaust hoods and particularly to an easily mounted exhaust hood and method of mounting an exhaust hood.

### BACKGROUND OF THE INVENTION

Exhaust hoods, such as those mounted above a cooking appliance such as a range or cooktop, have existed for many years. These hoods typically include an electric motor which is coupleable with a venting duct positioned within the walls of a home or other structure.

The mounting of these hoods is cumbersome as one must typically hold the heavy hood in place above the cooktop while simultaneously threading screws through screw holes in the hood and into an overlying structure, such as a cabinet, soffit or other structural element.

Accordingly, it is seen that a need remains for a range hood that can be mounted in a quick and easy fashion. It is to the provision of such therefore that the present invention is primarily directed.

### SUMMARY OF THE INVENTION

In a preferred form of the invention an exhaust hood which is mounted to a support structure comprises a housing having a front wall, a rear wall, side walls, and a top wall. The rear wall has a bottom edge. The hood also includes at least one rear mounting bracket mounted to the support structure and having a catch portion configured to engage and support the rear wall of the housing, and at least one front mounting bracket mounted to the support structure and adapted to engage and be locked upon the top wall of the housing in an area adjacent the front wall.

In another preferred form of the invention, a method of mounting an exhaust hood comprises the steps of mounting at least one rear mounting bracket to a support structure, mounting at least one front mounting bracket to a support structure, providing an exhaust hood housing, catching a portion of the exhaust hood housing upon the rear mounting bracket so as to support a portion of the weight of the housing upon the rear mounting bracket, raising the exhaust hood housing to a position wherein the exhaust hood housing engages the front mounting brackets, and locking the exhaust hood housing to said front mounting bracket.

### BRIEF DESCRIPTION OF THE DRAWING

FIG. 1 is a perspective view of an exhaust hood, shown with surrounding structure and in partial cross-section, that embodies principles of the invention in its preferred form.

FIG. 2 is a perspective view of the mounting brackets and surrounding structure of the exhaust hood of FIG. 1.

FIG. 3 is a perspective view of the exhaust hood and surrounding structure of FIG. 1.

FIG. 4 is a perspective view of the exhaust hood and surrounding structure of FIG. 1, shown in a mounted configuration.

### DETAILED DESCRIPTION

With reference next to the drawings, there is shown an exhaust hood 10 in a preferred form of the invention. The exhaust hood 10 has housing 11 with a front wall 12, a rear wall 13, two oppositely disposed side walls 14, a top wall 15, and an open bottom 16. The exhaust hood may also include an unshown electric motor which is coupled to an unshown exhaust vent duct. The top wall 15 has a pair of key-hole shaped mounting holes 19 therein positioned in an area adjacent the front wall 12. Each key-hole shaped mounting hole 19 has an enlarged portion 20 extending to an elongated narrow portion 21. The rear wall 13 has a bottom edge 23 which is generally coextensive with the a bottom edge 24 of the side walls 14.

The exhaust hood 10 also includes a pair of rear mounting brackets 26 and a pair of front mounting brackets 27. Each rear mounting bracket 26 includes a generally horizontally oriented first portion 29, a generally vertically oriented second portion 30, a generally horizontally oriented third portion 31, an elongated, generally vertically oriented fourth portion 32 terminating at a hook portion 33. First, second and fourth portions include mounting holes 34 therethrough. The second and third portions form a ledge 35. Rear bracket mounting screws 36 are configured to pass through mounting holes 34 and into underlying structure adjacent the rear bracket 26.

Each front mounting brackets 27 includes a generally horizontally oriented first portion 40, a generally vertically oriented second portion 41, and a generally horizontally oriented third portion 42. The first and second portions include mounting holes 43 therethrough. A hood mounting screw 44 is threadably mounted to the third portion. Front bracket mounting screws 45 are configured to pass through mounting holes 43 and into underlying structure adjacent the front bracket 27 to support the front bracket upon the structure.

The front and rear brackets 26 and 27 may include a layer of adhesive tape 47 which enables the brackets to be temporarily mounted to the overlying structure prior to and during the threading of the corresponding mounting screws 36 and 45.

In use, the rear brackets 26 are positioned against the rear wall of a structure wherein the exhaust hood 10 is to be positioned. This structure typically is a space defined by cabinetry, as such, the space typically includes a wood strip WS shown in the drawings. The wood strip WS may require the rear bracket to be formed with ledge 35 to facilitate the mounting of the bracket and the strength or holding capability of the rear bracket, however, such wood strips are option. The rear mounting brackets 26 are temporarily secured in place through adhesive tape 47 and subsequently permanently secured in place by passing mounting screws 36 through mounting holes 34 and into the adjacent structure, whether that be wood strip WS, cabinetry, a structural wall, or the other similar structure. The selection of which mounting hole 34 to utilize depends upon the adjacent structure.

The front brackets 27 are positioned against the support structure in a position wherein the hood mounting screws 44 align with the narrowed portion 21 of the key-hole shaped mounting holes 19. The front brackets 27 are secured in place initially with adhesive tape 47 and then in a more permanent fashion by passing mounting screws 45 through mounting holes 43 and into the adjacent structure.

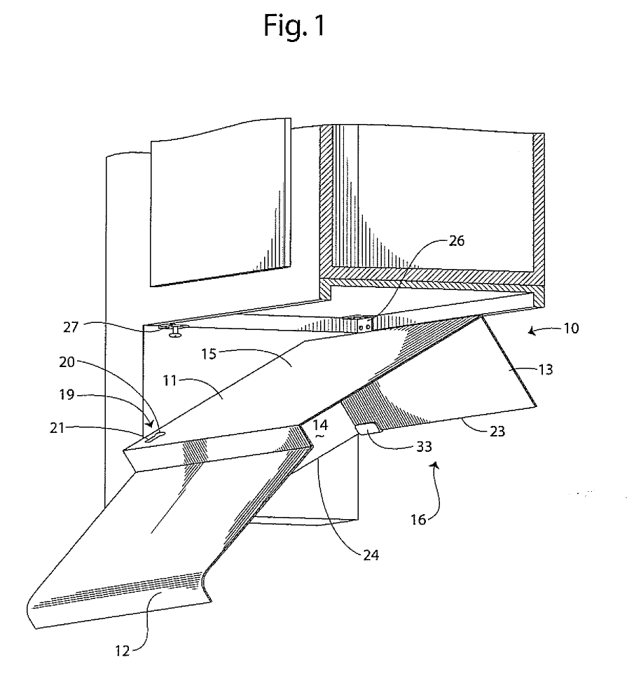

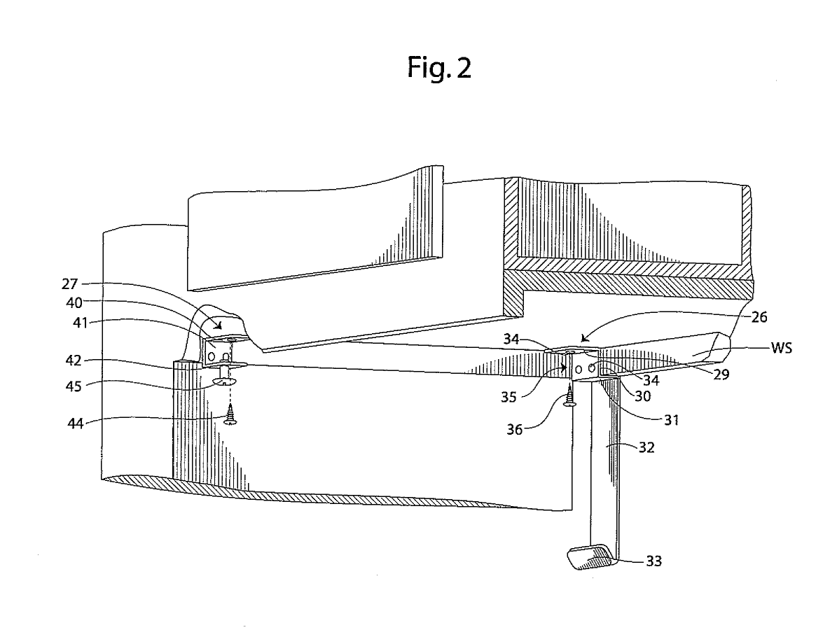

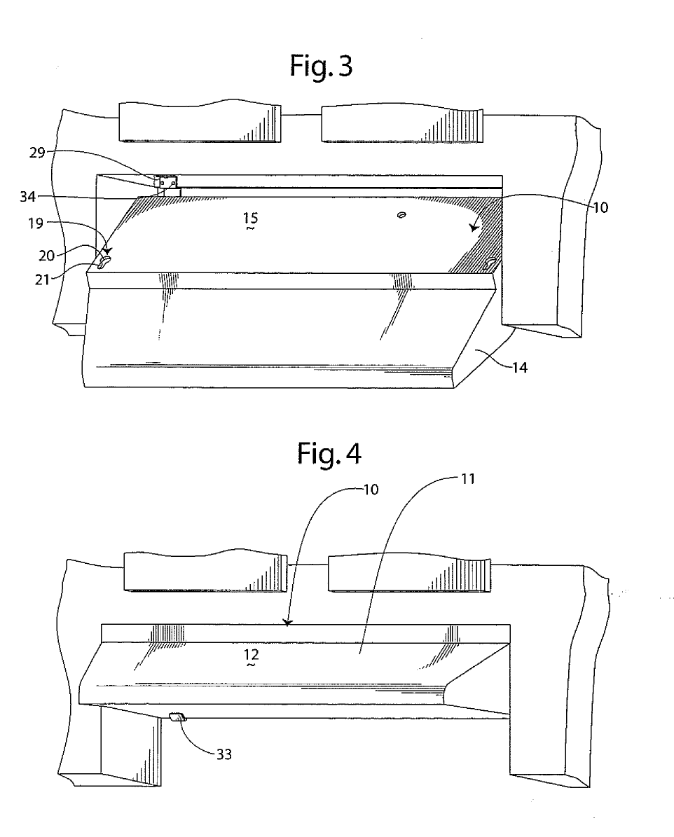

Once the front and rear brackets are mounted in place, the hood housing 11 is raised to a level wherein the hood housing rear wall bottom edge 23 is raised over the level of the hook portion 33 of the rear bracket 26. The bottom edge 23 of the rear wall is then rested upon the interior bite or bend of the hook portion, as shown in FIG. 1. With the majority of the exhaust hood's weight now resting upon the rear mounting brackets 26 the hood front end is raised to a position wherein hood mounting screws 44 pass through the enlarged portion 20 of the key-hole shaped mounting holes 19. With the hood mounting screws 44 passing through the key-hole shaped mounting holes 19, the exhaust hood housing 11 is slid or moved rearwardly so that the hood mounting screws 44 reside within the narrowed portion 21 of the key-hole shaped mounting holes. The hood mounting screws 44 are then rotated or screwed into the front mounting bracket third portion 42 to tightly press against the hood top wall 15, thereby locking the exhaust hood housing 11 in place as shown in FIG. 4.

It should be understood that the rear mounting bracket 26 may be made of a flexible material to allow the forward and rearward motion of the exhaust hood upon the rear bracket. It should also be understood that the rear mounting brackets may also be mounted to the side walls 149, preferably in a position towards the rear wall 13.

It thus is seen that an improved exhaust hood is now provided which is easily mounted to a structure. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. An exhaust hood of the type adapted to be mounted to a support structure, the exhaust hood comprising:
a housing having a front wall, a rear wall, side walls, and a top wall, said rear wall having a bottom edge;
at least one rear mounting bracket mounted to the support structure and having a catch portion configured to engage and support said rear wall of said housing, and
at least one front mounting bracket mounted to the support structure and adapted to engage and be locked upon said top wall of said housing in an area adjacent said front wall.

2. The exhaust hood of claim 1 wherein said rear mounting bracket catch portion is hook shaped portion.

3. The exhaust hood of claim 1 wherein said front bracket includes a hood mounting screw and wherein said top wall includes a mounting hole therein configured to receive said mounting screw.

4. The exhaust hood of claim 3 wherein said top wall mounting hole is a key-hole shaped mounting hole.

5. The exhaust hood of claim 4 wherein said rear mounting bracket catch portion is a hook shaped portion.

6. The exhaust hood of claim 1 further comprising a second rear bracket and a second front bracket.

7. An exhaust hood configured to be mounted to a support structure comprising:
a housing;
a first mounting bracket adapted to engage said housing, said first mounting bracket being configured to allow pivotal movement of said housing between an initially engaged position and a fully mounted position;
a second mounting bracket adapted to engage said housing and lock said housing to the support structure, and
said first and second brackets adapted to support said housing upon the support structure.

8. The exhaust hood of claim 7 wherein said first mounting bracket includes a hook portion adapted to capture a portion of said housing.

9. The exhaust hood of claim 7 wherein said housing includes a top wall with a mounting hole therein and wherein said second bracket includes a hood mounting screw configured to be received within said top wall mounting hole.

10. The exhaust hood of claim 9 wherein said top wall mounting hole is a key-hole shaped mounting hole.

11. The exhaust hood of claim 7 further comprising a second first mounting bracket and a second second mounting bracket.

12. A method of mounting an exhaust hood comprising the steps of:
(A) mounting at least one rear mounting bracket to a support structure;
(B) mounting at least one front mounting bracket to a support structure;
(C) providing an exhaust hood housing;
(D) catching a portion of the exhaust hood housing upon the rear mounting bracket so as to support a portion of the weight of the housing upon the rear mounting bracket;
(E) raising the exhaust hood housing to a position wherein the exhaust hood housing engages the front mounting brackets, and
(F) locking the exhaust hood housing to said front mounting bracket.

13. The method of claim 12 wherein step (A) the rear mounting bracket has a hook-shaped portion, and wherein step (D) the hook-shaped portion catches the housing.

14. The method of claim 12 wherein step (F) the exhaust hood housing is locked through a mounting screw passing through a mounting hole in the housing.

15. The method of claim 14 wherein said mounting hole is a key-hole shaped mounting hole.
